(19) United States
(12) Patent Application Publication
(10) Pub. No.: US 2014/0312142 A1
(43) Pub. Date: Oct. 23, 2014

(54) Multi-Configuration Misting and Spraying System

(71) Applicant: Rod Lovett, Katy, TX (US)

(72) Inventor: Rod Lovett, Katy, TX (US)

(21) Appl. No.: 14/204,001

(22) Filed: Mar. 11, 2014

Related U.S. Application Data
(60) Provisional application No. 61/794,405, filed on Mar. 15, 2013.

(51) Int. Cl. A01M 7/00; B05B 9/00; B05B 9/04

(52) U.S. Cl. CPC A01M 7/0032; B05B 9/0403; B05B 9/007
USPC 239/146; 239/302

(57) ABSTRACT

An insecticide delivery system for delivering insecticide or other liquids through either stationary or portable misting or by spot spraying. A delivery system includes a liquid reservoir, a fluid misting pump to flow insecticide liquid to installed misting nozzles and a fluid spraying pump to flow insecticide liquid to a spraying wand.

### BACKGROUND OF THE INVENTION

1. Field of the Invention

The invention relates generally to devices and methods for delivering insecticide and other liquids. In particular aspects, the invention relates to a unit that can be used for general area misting or for spot spraying of insecticides or other liquids.

2. Description of the Related Art

Misting systems have been developed that dispense insecticide. However, misting operations are largely performed by installed units that require an installed fluid circuit. These systems are capable of dispensing insecticide over a large area. However, they are largely incapable of spot-treating small individual points with insecticide. In addition, they are only able to spray a limited variety of fluids (i.e., various insecticides).

### SUMMARY OF THE INVENTION

The present invention provides systems and methods that allow for large-area general misting as well as portable misting and spot spraying of small areas. An exemplary multi-configuration misting system is described in the form of an insecticide delivery unit that allows a user to mist the insecticide, or other liquid, through an installed misting circuit as well as to spray insecticide (or another liquid) using a spray wand. In a described embodiment, the insecticide delivery unit includes a misting section and a spraying section. An exemplary misting section includes a fluid reservoir, fluid misting pump, motor, power supply and a programmable controller. An exemplary spraying section includes a spraying pump, a three-way valve and a spray wand. Preferably, the components and features of the insecticide delivery unit are contained within or mounted upon a housing that is moveable upon wheels. One or more fluid delivery ports are preferably located on the housing.

The controller is preferably programmable and adapted to control the operation of the fluid pump, motor and valves to perform misting in accordance with preprogrammed schemes. A user may select among a number of insecticide delivery configurations using the controller.

In other aspects, selected embodiments of the present invention include an agitation system which agitates the liquid additives, thereby ensuring proper suspension of solid components of the additive. In particular embodiments, the agitation system agitates insecticide liquid within both the internal fluid reservoir of the portable unit as well as the liquid contained within an external feeding tank. Also in other aspects, selected embodiments of the invention can include a liquid level sensing system and/or a pressure switch to shut off the pump in the event of a stuck valve or other malfunction.

### BRIEF DESCRIPTION OF THE DRAWINGS

For detailed understanding of the invention, reference is made to the following detailed description of the preferred embodiments, taken in conjunction with the accompanying drawings in which reference characters designate like or similar elements throughout the several figures of the drawings.

FIG. 1 is a side view of an exemplary insecticide delivery system constructed in accordance with the present invention.

FIG. 2 is a front view of the insecticide delivery system shown in FIG. 1.

FIG. 3 is an internal view of components that are located within the lower spraying section of the insecticide delivery system.

FIG. 4 is a view of an exemplary control interface that can be used with the insecticide delivery system shown in FIGS. 1-3.

FIG. 5 is an internal view of components that are located largely within the upper misting section of the insecticide delivery system.

FIG. 6 is rear view of the exemplary insecticide delivery system.

### DETAILED DESCRIPTION OF THE PREFERRED EMBODIMENTS

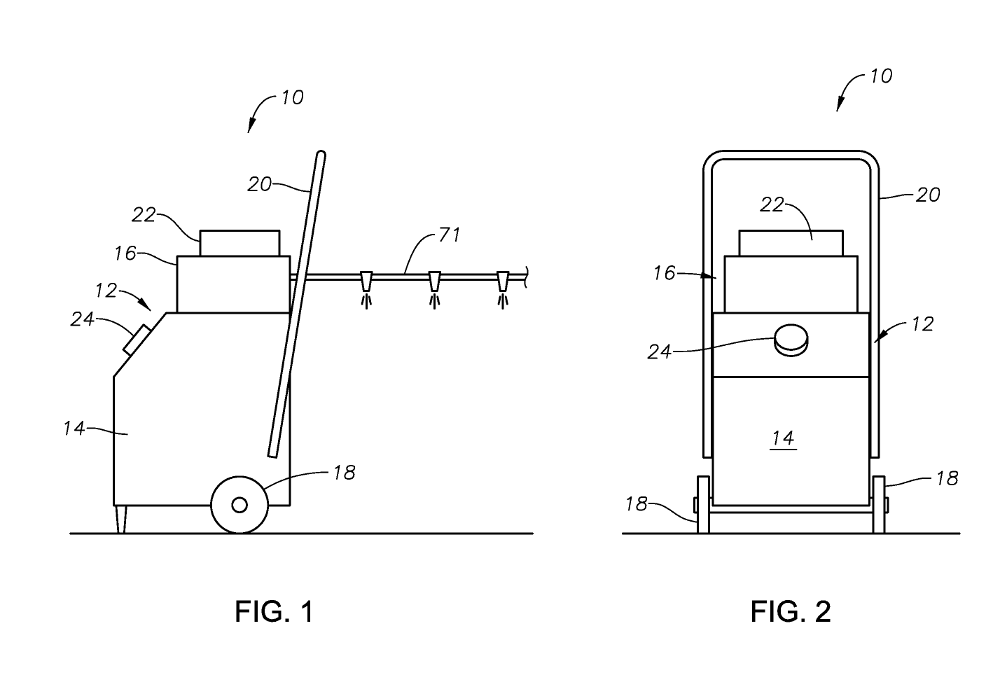

FIGS. 1-2 depict an exemplary insecticide delivery system 10 which is constructed in accordance with the present invention. The system 10 includes a is portable unit 12 that generally includes a lower, spraying section 14 and an upper, misting section 16. The unit 12 preferably has wheels 18 and a grippable handle 20 to permit the unit 12 to be easily moved from place to place. The upper misting section 16 includes a hinged cover 22 that can be opened to access a controller interface. A removable cap 24 is provided to allow an internal insecticide tank to be filled manually.

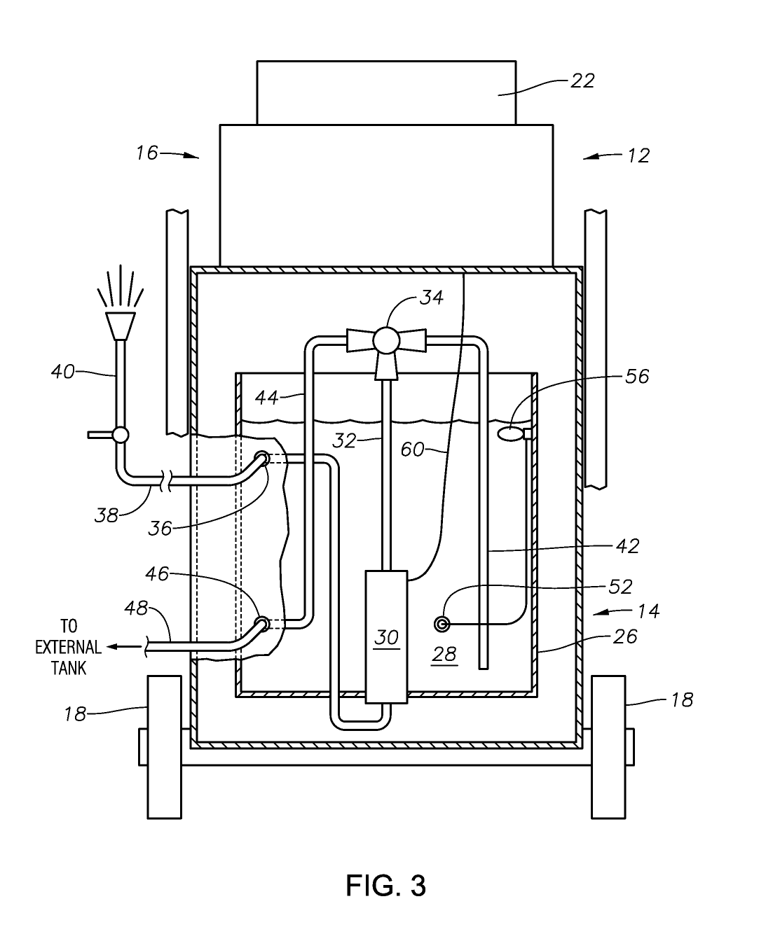

FIG. 3 illustrates a number of components that are largely contained within the lower spraying section 14. The lower spraying section 14 contains an internal liquid reservoir or tank 26 that is designed to retain insecticide liquid 28 or a similar liquid. A motorized fluid spraying pump 30 is operably associated with a conduit 32 to three-way fluid inflow valve 34. The pump 30 will flow fluid from the fluid inflow valve 34 to spray wand outlet 36. The spray wand outlet 36 may be a quick-connect type fitting of a type known in the art for quickly attaching and detaching a hose or conduit. FIG. 3 illustrates a conduit 38 and spray wand 40 secured to the spray wand outlet 36. The fluid inflow valve 34 can be switched between two positions, each position allowing the spraying pump 30 to draw fluid from a different source. In a first position, the pump 30 draws fluid from internal tank 26 via fluid conduit 42. In a second position, the pump 30 draws fluid from an external tank or source via fluid conduit 44. Fluid conduit 44 extends from the three way valve 34 and external tank connection port 46. A conduit 48 which is associated with an external fluid source is shown affixed to the connection port 46.

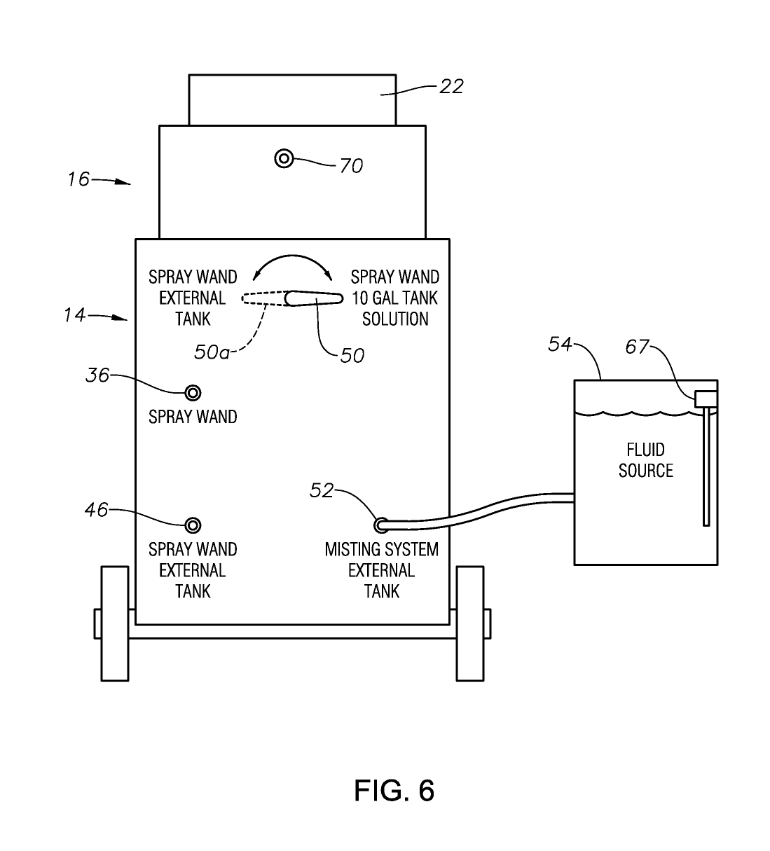

FIG. 6 illustrates an external flip-switch 50 which may be gripped by a user and rotated between the positions shown at 50 and 50a in order to switch the fluid inflow valve 34 between its two positions. If it is desired to spot spray another liquid other than insecticide, the fluid inflow valve 34 is switched to its second position so that liquid is drawn from fluid conduit 44 and from an external fluid reservoir. The external fluid reservoir can contain weed killer, fungicide or other useful liquids.

The internal liquid tank 26 also preferably includes a further external tank connection port 52 through which the liquid tank 26 can be filled by an external fluid source 54 (see FIG. 6). It is noted that the insecticide delivery system 10 may be affixed to the external source 54 when it is not in use so that the internal liquid tank 26 can be filled by the external source 54. In certain embodiments, the internal tank 26 is provided with a float switch 56 (see FIG. 3), of a type known in the art, that is adapted to detect when the level of insecticide fluid 28 is low and in response, open connection port 52 to allow filling of the internal tank 26 from the external fluid source 54. When the internal tank 26 is filled, the float switch 56 closes off the connection port 52 to further filling. In particular embodiments, the external fluid source 54 may be a 55 gallon drum, and the internal tank may be a 10 gallon tank.

FIG. 5 illustrates a number of components that, in the described embodiment, are largely located within the upper, misting section 16 of the system 10. A portable power source 58 is provided which may be a rechargeable battery of a type known in the art. In other embodiments, the power source 58 may be or include a suitable solar panel to collect solar power that can be provided to power the system components or to charge a battery within the power source. The power source 58 provides power (via cable connection 60) to the spraying pump 30. In addition, the power source 58 provides power to motorized misting pump 62, controller board 64 and agitator 66. When actuated, the misting pump 62 will draw fluid from the internal fluid tank 26 via conduit 68 and flow the fluid to a misting system connection port 70. The feeder conduit of a stationary installed mosquito misting system (such as system 71 shown in FIG. 1) can be attached to the misting system connection port 70. Such installed mosquito misting systems are known in the art and typically include a circuit of nozzles that are strategically placed around the perimeter of an area to be misted, such as a residential yard.

The agitator 66 can be actuated by the controller 64 to agitate and mix the insecticide fluid 28 by directing the output of the misting pump 62 through tube 72 and back into the insecticide liquid 28 within the internal reservoir 26. In certain embodiments, the agitator 66 may also actuate an agitation pump 67 within the external fluid source 54 (see FIG. 6) when a wired or wireless communication link, of a type known in the art is used to link the agitator 66 with agitation pump 67. Thus, it can be seen that the agitation system of the present invention allows for proper mixing of insecticide liquids in both the internal reservoir 26 and the external source 54. The agitator 66 is actuated by the controller 64 in accordance with preprogrammed schedules.

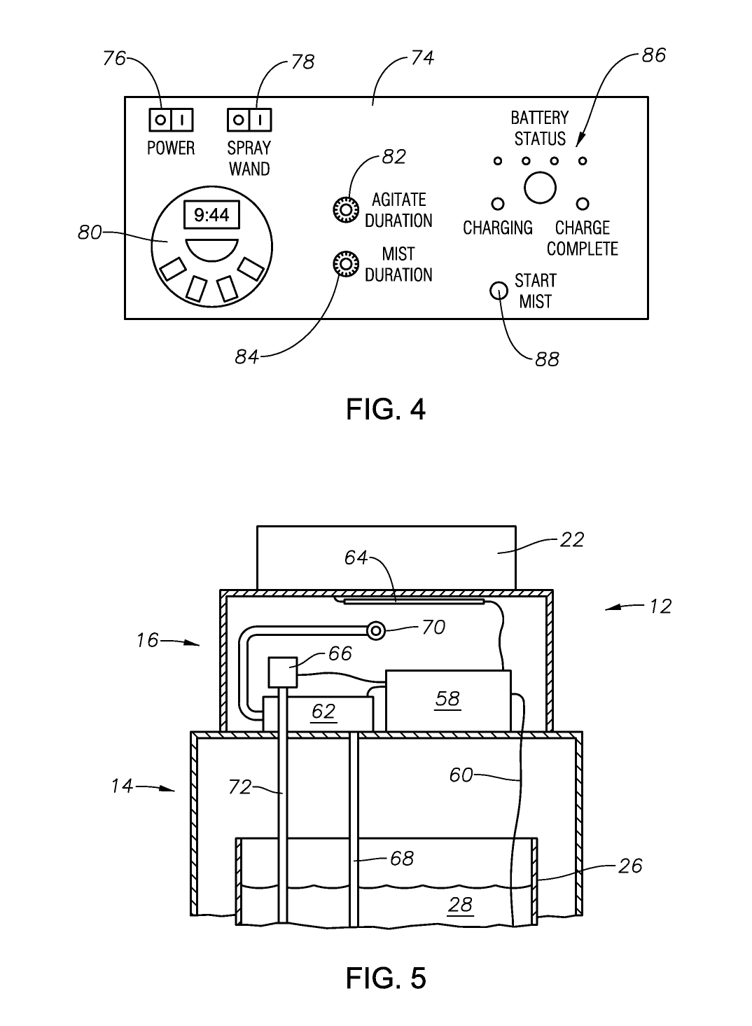

FIG. 4 illustrates an exemplary user interface panel 74 which might be used to program the controller 64 and its controlled components. The interface panel 74 is preferably located beneath the hinged cover 22 of the upper misting section 16. However, it could be located in other places on the unit 12. The exemplary interface panel 74 includes a toggle or other switch 76 that will turn the power of the unit 12 on or off. A toggle or other switch 78 is also provided that will turn on or off the spray wand feature wherein the spraying pump 30 is actuated to flow insecticide fluid 28 to the spray wand 40. A timer module 80 can be used to program scheduled times for misting and/or agitation of the interior tank 26. Dial or similar control 82 is used to set and adjust the duration of an agitation operation. Dial/control 84 is used to set and adjust the duration of a misting operation. Indicator lights 86 are used to depict the charge level and status of the power source 58. A button 88 is provided to manually actuate a misting operation.

Via the panel 74, the controller 64 can be programmed with multiple misting parameters set by the user so that insecticide misting may be conducted with the use of a stationary, installed nozzle circuit in accordance with preprogrammed misting instructions. These parameters include, but are not limited to, misting times, misting durations, and manual misting. The controller 64 would actuate the misting pump 62 to flow insecticide liquid 28 from the insecticide reservoir 26 through misting system connection port 70 and into an installed misting circuit. In addition, the controller 64 will actuate the agitator 66 to agitate and mix the insecticide liquid 28 at predetermined times and durations according to a predetermined schedule. Additional details relating to the programming of a controller are described in U.S. Pat. No. 7,090,147 entitled “Mosquito Misting System” which was issued to the inventor of the present invention. U.S. Pat. No. 7,090,147 is incorporated herein in its entirety.

The controller 64 might also be provided with a wind sensor that provides the controller 64 with signals indicative of wind velocity. The controller 64 can be programmed to cancel a particular misting operation in the event that wind velocity is too great.

It can be seen that the invention provides devices and methods that permit misting through an installed misting system as well as spot spraying of insecticide from a single source—reservoir 26. The system 10 is versatile and allows spraying of insecticide or other useful chemicals with a single spray wand 40. In addition, the system 10 allows spraying of useful liquids other than insecticides provided via conduit 48.

The insecticide delivery system 10 has been designed to enable insect control in areas where commercially supplied electrical power is not readily available. These areas range from, but are not limited to, commercial sites, garbage areas, boat docks, cabins, horse barns, military camps, pet kennels; countries where the electrical supply differs from the United States, and third world countries.

Those of skill in the art will recognize that numerous modifications and changes may be made to the exemplary designs and embodiments described herein and that the invention is limited only by the claims that follow and any equivalents thereof.

What is claimed is:

1. An insecticide delivery system comprising:
a fluid reservoir containing an insecticide liquid;
a fluid spraying pump operably interconnected with the fluid reservoir to draw fluid from the fluid reservoir and transmit it to a spraying nozzle; and
an inflow valve associated with the fluid spraying pump, the inflow valve being moveable between a first position wherein the fluid spraying pump draws fluid from the fluid reservoir and a second position wherein the fluid pump draws fluid from an external fluid source.

2. The insecticide delivery system of claim 1 further comprising a fluid misting pump to draw insecticide liquid from the fluid reservoir and deliver it to an installed misting nozzle circuit.

3. The insecticide delivery system of claim 2 further comprising a controller that is operably associated with the fluid misting pump to actuate the fluid misting pump in accordance with preprogrammed misting instructions.

4. The insecticide delivery system of claim 3 further comprising a power source to provide power to the controller and the fluid misting and fluid spraying pumps.

5. The insecticide delivery system of claim 4 wherein the power source is a rechargeable battery.

6. The insecticide delivery system of claim 1 wherein the fluid reservoir, fluid spraying pump and inflow valve are contained within a unit having wheels that permit the unit to be portably moved about.

7. The insecticide misting system of claim 3 further comprising an agitator operably associated with the controller and adapted to mix liquid within the fluid reservoir by agitation.

8. An insecticide delivery system comprising:
a fluid reservoir containing an insecticide liquid to be misted;
a fluid spraying pump operably interconnected with the fluid reservoir to draw fluid from the fluid reservoir and transmit it to a liquid spraying nozzle; and
a fluid misting pump to draw insecticide liquid from the fluid reservoir and deliver it to an installed misting nozzle circuit.

9. The insecticide delivery system of claim 8 further comprising an inflow valve associated with the fluid misting pump, the inflow valve being moveable between a first position wherein the fluid pump draws fluid from the fluid reservoir and a second position wherein the fluid pump draws fluid from an external fluid source.

10. The insecticide delivery system of claim 8 further comprising a controller that is operably associated with the fluid misting pump to actuate the fluid misting pump in accordance with preprogrammed misting instructions.

11. The insecticide delivery system of claim 10 further comprising a power source to provide power to the controller and the fluid misting and spraying pumps.

12. The insecticide delivery system of claim 11 wherein the power source is a rechargeable battery.

13. The insecticide delivery system of claim 8 wherein the fluid reservoir, fluid spraying pump and fluid misting pump are contained within a unit having wheels that permit the unit to be portably moved about.

14. The insecticide misting system of claim 10 further comprising an agitator operably associated with the controller and adapted to mix liquid within the fluid reservoir by agitation.

15. The insecticide misting system of claim 14 wherein the agitator is also operably interconnected with an agitation pump for mixing fluid within an external fluid source by agitation.

16. An insecticide delivery system comprising:
a fluid reservoir containing an insecticide liquid to be misted;
a fluid spraying pump operably interconnected with the fluid reservoir to draw fluid from the fluid reservoir and transmit it to a liquid spraying nozzle;
a fluid misting pump to draw insecticide liquid from the fluid reservoir and deliver it to an installed misting nozzle circuit; and
a controller operably associated with the fluid misting pump to actuate the fluid misting pump in accordance with preprogrammed misting instructions.

17. The insecticide delivery system of claim 16 further comprising an inflow valve associated with the fluid misting pump, the inflow valve being moveable between a first position wherein the fluid pump draws fluid from the fluid reservoir and a second position wherein the fluid pump draws fluid from an external fluid source.

18. The insecticide delivery system of claim 16 further comprising a power source to provide power to the controller and the fluid misting and spraying pumps.

19. The insecticide delivery system of claim 18 wherein the power source is a rechargeable battery.

20. The insecticide delivery system of claim 18 wherein the power source includes a solar power source.
